(19) United States
(12) Patent Application Publication
(10) Pub. No.: US 2006/0062959 A1
(43) Pub. Date: Mar. 23, 2006

(54) Light prefabricated module made from natural reed and used as a construction element

(76) Inventor: Mata Solis Gerardo Elpidio, Monterrey (MX)

Correspondence Address: BAKER & MCKENZIE LLP;PATENT DEPARTMENT, 2001 ROSS AVENUE, SUITE 2300, DALLAS, TX, 75201, US

(21) Appl. No.: 10/512,932

(22) PCT Filed: Apr. 30, 2002
(86) PCT No.: PCT/MX02/00037

§ 371 Date: Jun. 29, 2005

(51) Int. Cl. B32B 5/12

(52) U.S. Cl. 428/105; 428/107

(57) ABSTRACT

The invention relates to a light prefabricated module which is made from natural reed and which can be used in construction as a versatile and easy-to-handle structural element. The inventive module offers direct benefits relating to cost and construction time savings, durability and comfort. More specifically, the invention relates to a novel element for use in the construction industry which is characterised in that it is of natural origin, reeds being 100% renewable in the short term (2 harvests per year), and by the simplicity with which the raw material thereof can be obtained. Said novel element combines the performance characteristics necessary to meet the desired requirements. The invention is further characterised by the simple assembly and technical handling procedures associated with same and by the use thereof in different types of construction where it can be used in roofs, walls, between floor slabs, terraces, huts, posts, columns, beams and other construction elements.

### FIELD OF THE INVENTION

The present invention refer to the building industry with a novel product of vegetable origin that has its components (natural canes) bundled into modules that can be used as structural elements.

### BACKGROUND OF THE INVENTION

At the moment, the prefabricated module that are used as structural element in housing, bridges, building, etc., are made of conventional materials commonly used in construction, such as: concrete, concrete blocks, polyestirene, etc. The prefabricated module can save handicraft on time and building cost, but with few benefits as far as acoustic and thermal insulation, light structural weight, production economy, manufacturing speed, and ease of installation.

Based on the above consideration and others, I thought of developing a product that could greatly contribute to the offering of worthy housing and of associated social concerns, but that could also be used in others types of constructions.

There are in the prior art canes compressed panel, reed/river canes or others vegetables stems, bounded by thin metallic frameworks and rings, with such stems can make arrays the multiple stems placed in parallel fashion, finally the panel is covered with a mortar made of clay, lime, cement. The cover or plaster is made in a handle way, but no inside a mould, and the plaster used is made by other mixture. A example is the panel described in the patent ES 217700, granted to Armonia-Teresa Gil y Tomás, on 16, Aug., 1976.

### BRIEF DESCRIPTION OF DRAWING

FIG. 1(A), represent a perspective view of the bundle of natural canes to make a laminar structural element (panel).

FIG. 1(B), represent a perspective view of the bundle of natural canes to make a triangular shape structural element.

FIG. 1(C), represent a perspective view of the bundle of natural canes to make a cylindrical shape structural element.

FIG. 2, represent a side view of the vertical used to give shape to the bundle of natural canes, hold with the metal wire rings or plastic belts.

FIG. 3, represent a perspective view of the mould, the bundle canes are placed inside to be covered with the mortar.

FIG. 4, represent a transverse view of the panel of natural canes outline used to assemble of modules.

### DETAILED DESCRIPTION OF THE INVENTION

The characteristics of this novel prefab/light-weight module of natural cane to be used as a construction element are clearly shown in the following description.

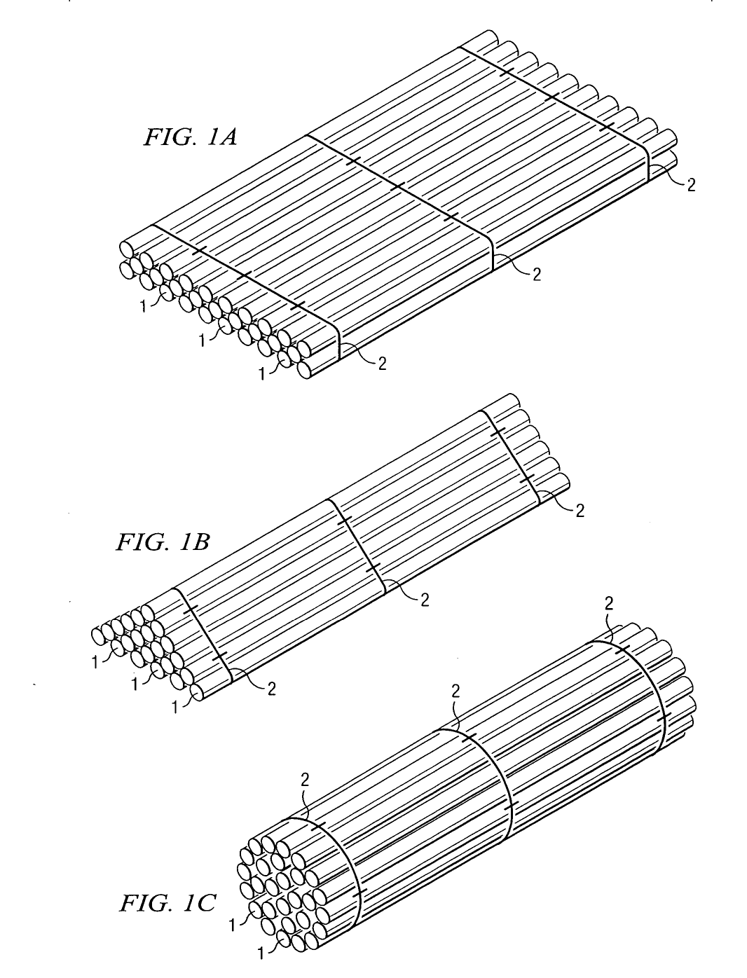

The module's structure is formed by natural cane, each with a diameter of 2.0 to 4.0 cm approximately, and a length between 1.0 and 6.0 m. depending on construction requirements in some construction element, the canes are tied together in the center and at the ends with 3.17 mm (⅛″) diameter wire or with metallic or plastic belts, in order for the module to take the required shape (rectangular, triangular, cylindrical, etc) (FIG. 1 A, B, C). achieving a thickness of between 10.0 and 20.0 cm.

With the purpose of given unity to the module and for easy handling, it may be covered, if desired, with mortar. The following is the mortar's formula:
40% by volume of clay of medium plasticity,
50% by volume of kenaf stalks about 2.5 cm of length,
5% by volume of cement dissolved in water,
5% by volume of lime.

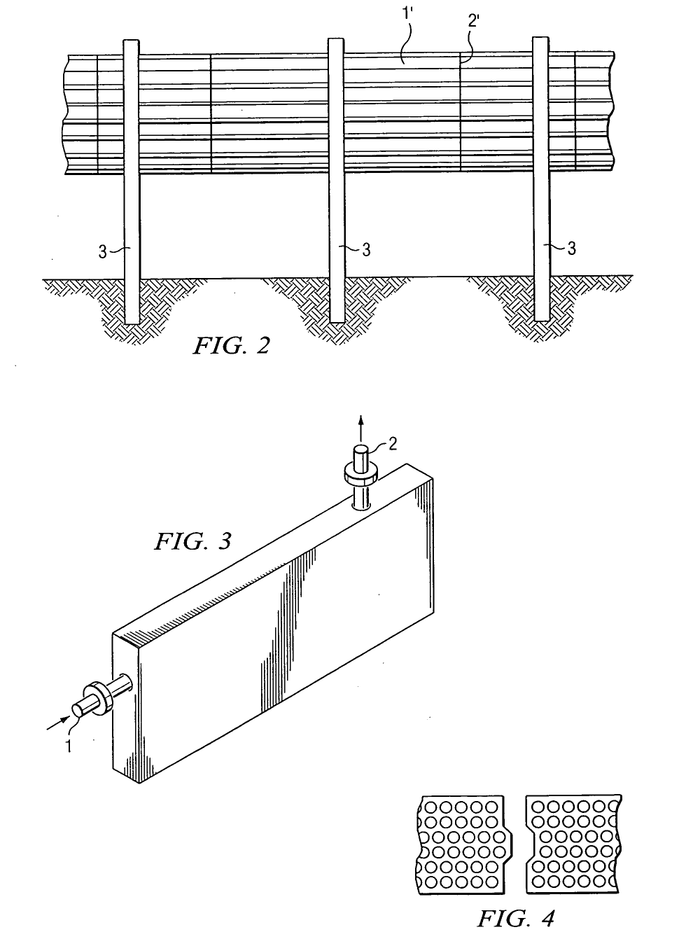

As a complement of this invention, the prefab/light-weight module of natural cane can be introduced into a (metallic, wood, glass fiber, plastic) mould or any other material that might be used as a container (FIG. 3) and injected under pressure with the previously described mortar or other substance with similar properties. In regard to the FIG. 3, the mortar is injected across of opening (11) made in a side mould, the air inside of the mould is dislodged by the volume of mortar that come in mould, the air to go out across the upper opening (12).

The shape and finish of the prefab/light-weight module will be given by the mould or container, including the coupling used to assemble the modules (FIG. 4).

Once the injected module dries it can be cut in sections to become an integrated part of domes, roofs, walls, floors, huts, etc.

The efficiency of module that involved in the object of the invention is the fact that:

The raw material of natural origin used in the module's fabrication can be of bundled canes of kenaf, king grass, sorghum, corn, sunflower, bamboo, etc, and for lighter structures you can also use reed/river cane preferably, but you can use any variety of natural cane with similar characteristics.

Just as with the essential components (canes) of the module, the mortar recommended for covering was designed with natural materials that highlight its ecological value, such as being biodegradable.

In test made at the lab, the behavioral properties of the prefab/light-weight module of natural cane were determined as an integral element of: walls, ceilings, domes, etc., with the followings results:

| Module's weight | 15.0 kg/m² |
|---|---|
| Area to cover approximately from | 1.0 to 6.0 m² |
| Minimum resistance to compression | 150.0 kg/cm² |
| Minimum resistance to tension | 150.0 kg/cm² |
| Mortar permeability | 0.0% |

The prefab/light-weight module (panel) is described clearly way using the figures, in fact. FIG. 1 show a perspective of the prefab/light-weight module of natural cane in three different models (FIG. 1 A, B,C) in which you can clearly appreciate it's structure formed by canes (1) tied with wire or with a plastic or metallic belts in the center and at the ends (2) of module, which confer the shape required. To be bounded the modules each other, wire of the same diameter will be used, achieving a mechanical joining, for the case when use the modules in natural appearance of canes.

FIG. 2 shows (support) it contain the vertical retainer (3) between the canes are placed in parallel fashion the canes (1′), in this way facilitate their being bound with the wire or belts (2′),

FIG. 3 shows a perspective view the mould of container on which you can place the prefab/light-weight module of natural cane for the injection of the mortar that will cover it and give it its desired finish (rustic, texturized, plain, etc., depending of the internal surface of mould). It has a opening (11) in which mortar will be administered and other upper opening (12) for the air expulsion from the inside of mould and the space between canes.

FIG. 4 shows a section view of the ends of the two prefab/light-weight module of natural canes, after being injected with the mortar and when dry, they will be assembled by the outline for connection system between modules.

Regarding to the illustrations, in the following describe the fabrication procedure of a module prefab/light-weight of natural canes:
a). The desired area to be covered will determine the size (length) to which the canes will be cut, between 1.0 and 6.0 m, like (FIG. 1 A, B, C).
b). The canes (1′) are placed between some retainers (3) FIG. 2, which will be them support so we can to pile up and hold them to be tied-up and to take the desired shape (FIG. 2, 2′).
c). The canes are tied with wire or belts (2) FIG. 1.
d). If covering them is desired, a mortar will hide the canes and will give the module a uniform appearance or a predetermined finish if it is introduced into a mould, the mould can place inside of the mould (FIG. 3). This mould has two holes (openings), one that (11) has the function of allowing the mortar to be administered by injection (FIG. 3) and the other (12) that is necessary for air expulsion that is inside of mould, before mortar injection (FIG. 3). Remark the mould position (FIG. 3), for help the mortar injection to fill by gravity action empty space between mould wells and the module.

e). One outside the mould and already dry, the prefab/light-weight module of natural cane, can be assembled with each other, if it is desired, by the connection system, as shown in the FIG. 4 (40), for their placement in walls, ceilings, floors, etc.

The particular embodiments the invention, will be obvious for person skills in the art so they can make modification or changes without out beyond the reach sought. The previous it intended cover with appended claims for all the changes and modifications will be in scope of the present invention.

1. Prefab/light-weight module of natural cane to be used as a construction element, made with a bundle of parallel fibers elements or natural canes (1) pressed each other, like reed/river cane, bamboo, kenaff, kingrass, cunflower, sorghum or corn, they group together to form bundles or modules with the same characteristics of wide, length, thickness, shape and diameter; such bundles are made by belts metallic or plastic placed longitudinal and transverse way (2) to provide fasten between canes and form a module about 10 and 20 cm of thickness, characterized by the bundles are rectangular transverse, triangular or cylindrical section and are covered under pressure (injected) with mortar inside of close mould that provide finished and superficial texture; such mortar is made by mixture of clay (40%), kenaff stalks (50%), cement-water (5%) and lime (5%).

2. Prefab/light-weight module of natural cane to be used as a construction element according to the claim 1, characterized by the mortar is injected under pressure by the opening (11) of side wall of the mould in this way the protection and finished to the bundle canes of module is provided, also is provided the outline (40) used to assemble the modules.

3. Prefab/light-weight module of natural cane to be used as a construction element according to the claim 1, characterizes by the mortar is made with clay, kenaff stalks, cement, water and lime in the following portions by volume per cent:
40% by volume of clay of medium plasticity,
50% by volume of kenaff stalks of about 2.5 cm of length,
5% by volume of cement dissolved in water,
5% by volume of lime.
